(19) United States
(12) Patent Application Publication
(10) Pub. No.: US 2013/0070573 A1
(43) Pub. Date: Mar. 21, 2013

(54) DIAL ASSEMBLY AND TIMEPIECE

(71) Applicant: Takumi OSHIO, Shiojiri (JP)

(72) Inventor: Takumi OSHIO, Shiojiri (JP)

(73) Assignee: SEIKO EPSON CORPORATION, Tokyo (JP)

(21) Appl. No.: 13/602,803

(22) Filed: Sep. 4, 2012

(30) Foreign Application Priority Data
Sep. 20, 2011 (JP) 2011-205222

(51) Int. Cl. G04B 19/06

(52) U.S. Cl. 368/235

(57) ABSTRACT

A dial assembly is held inside a timepiece case together with a movement that supports an hour hand and minute hand to be able to rotate. The dial assembly includes a plate shaped dial, and at least one decorative structure having a decorative member which can be visually recognized from the front side of the dial and a support member by which the decorative member is supported on the dial. The dial has a fixing member for fixing the decorative member, which is constituted with through holes that pierce the dial in the thickness direction. In a state in which the decorative member and the support member are assembled, the decorative structure is inserted in the fixing part from the front side of the dial to be fixed.

### CROSS-REFERENCE TO RELATED APPLICATIONS

This application claims priority to Japanese Patent Application No. 2011-205222 filed on Sep. 20, 2011. The entire disclosure of Japanese Patent Application No. 2011-205222 is hereby incorporated herein by reference.

### BACKGROUND

1. Technical Field

The present invention relates to a dial assembly and a timepiece.

2. Background Technology

With well-known wrist watches, there are items known which have a dial, and plate piece shaped display members respectively correlating to numbers 1 to 12 expressing time, a plurality of which are arranged on the front side surface of the dial (see Patent Document 1, for example). With the watch noted in this Patent Document 1, rod shaped leg parts are formed projecting as an integral unit on the back side surface of the display member. Meanwhile, attachment holes in which the leg parts are inserted are formed on the dial at the positions at which each display member is respectively arranged. Then, each display member is fixed by the leg parts being respectively inserted in the attachment holes from the front surface of the dial, and the leg part in that inserted state being tightened from the back side of the dial. With this kind of fixing method, each display member is in a state projecting to the front side surface of the dial by the amount of its thickness.

However, with the watch noted in Patent Document 1, depending on the display member thickness, specifically, on the projection volume of the display member from the front side surface of the dial, there is the risk of interference by that display member with the hour hand or minute hand, and to prevent that, it was necessary to make the hour hand and the minute hand extremely short. Then, when the hour hand and the minute hand were made extremely short, the watch was not very attractive.

Japanese Laid-open Patent Application No. 2000-275360 (Patent Document 1) is an example of the related art.

### SUMMARY

### Problems to be Solved by the Invention

An advantage of the invention is to provide a dial assembly for which it is possible to suppress the projection of the decorative member from the front side surface of the dial, and a timepiece equipped with that dial assembly.

### Means Used to Solve the Above-Mentioned Problems

Such an advantage is achieved by the invention noted below.

The dial assembly of the invention is a dial assembly which is held inside a timepiece case together with a movement that supports an hour hand and minute hand to be able to rotate, the dial assembly including:

a plate shaped dial, and

at least one decorative structure having a decorative member which can be visually recognized from the front side of the dial, and a support member by which the decorative member is supported on the dial, wherein

the dial has a fixing member for fixing the decorative member, which is constituted with through holes that pierce the dial in the thickness direction, and

in a state in which the decorative member and the support member are assembled, the decorative structure is inserted in the fixing part from the back side of the dial to be fixed.

As a result, it is possible to insert the decorative structure from the back side, and compared to when inserting the decorative structure from the front side, by the amount of the overall thickness of the dial, of the overall thickness (height) of the decorative structure, it is possible to suppress to the extent possible the projection of the decorative member from the front side surface of the dial.

With the dial assembly of the invention, preferably, with the decorative structure, one portion projects from the front side surface of the dial, and of the hour hand and the minute hand, at least the minute hand passes through the front side further than that one portion.

As a result, at least when the minute hand rotates, that minute hand is prevented from interfering with the decorative member of the decorative structure, and thus, it is possible to pass through the front surface further than the decorative member. Also, it is not necessary to shorten the minute hand, and thus, it is possible to prevent degrading of the attractiveness of the timepiece.

With the dial assembly of the invention, preferably, the support member is constituted with a block unit, and a projecting part is formed projecting to the side surface, engaging with the edge part of the fixing part, and regulates the insertion depth in relation to the fixing part.

As a result, the insertion depth of the support member in relation to the fixing part is reliably regulated, and thus, it is possible to reliably prevent excessive insertion of the support member or insufficient insertion of the support member, specifically, it is possible to insert the support member in the fixing part in just the right proportion.

With the dial assembly of the invention, preferably, the support member is constituted with a block unit, and on the front side surface is formed a recess part in which the decorative member is held.

As a result, it is possible to reliably fix the decorative member. It is also possible to reliably expose the part to specifically be exposed of the decorative member, specifically, the part other than the part held in the recess of the decorative member, making it possible to show the concerned part reliably from the front side.

With the dial assembly of the invention, preferably, a plurality of claw parts are formed projecting on the front side surface of the support member at positions different from the recess parts, and

each of the claw parts is respectively bent and engaged with the decorative member in a state with the decorative member held in the recess part.

As a result, each bent claw part is respectively plastically deformed, and that bent state is maintained. Then, each claw part can respectively be engaged with the exposed part of the decorative member held in the recess. With this kind of engaging, the decorative member is reliably supported and fixed on the support member, and thus, it is possible to reliably prevent unintended falling off from the support member.

With the dial assembly of the invention, preferably, the decorative member is a jewel.

As a result, it is possible to constitute the decorative member from among jewels such as a diamond, for example. Also, a timepiece having a decorative member constituted by diamonds has it aesthetic sense increase, and also becomes a luxury good (when the timepiece is a wrist watch, it is a so-called “luxury wrist watch”).

With the dial assembly of the invention, preferably, the decorative structure is an item corresponding to at least one number among 1 to 12 expressing time on the dial.

As a result, it is possible to have the hour hand and minute hand respectively indicate decorative structures fixed on the fixing part. It is also possible to recognize the time according to the positions that the hour hand and minute hand respectively indicate.

The timepiece of the invention is equipped with the dial assembly of the invention,

a movement that supports an hour hand and minute hand to be able to rotate, and

a case in which the dial assembly and movement are held.

As a result, it is possible to insert the decorative structure from the back side, and compared to a case when inserting the decorative structure from the front side, it is possible to obtain a timepiece for which, by the amount of the overall thickness of the dial, of the overall thickness (height) of the decorative structure, it is possible to suppress to the extent possible the projection of the decorative member from the front side surface of the dial.

### BRIEF DESCRIPTION OF THE DRAWINGS

Referring now to the attached drawings which form a part of this original disclosure:

FIG. 1 is a perspective view showing an embodiment when the timepiece of the invention equipped with the dial assembly of the invention is used for a wrist watch;

FIG. 2 is a cross section diagram of line A-A in FIG. 1.;

FIG. 3 is a diagram (plan view) of the dial assembly in FIG. 1 seen from the arrow B direction;

FIG. 4 is a perspective view of a decorative structure with the timepiece shown in FIG. 1;

FIG. 5 is a cross section showing the assembly step order of the dial assembly of the invention;

FIG. 6 is a cross section showing the assembly step order of the dial assembly of the invention;

FIG. 7 is a cross section showing the assembly step order of the dial assembly of the invention;

FIG. 8 is a cross section showing the assembly step order of the dial assembly of the invention; and

FIG. 9 is a cross section showing the assembly step order of the dial assembly of the invention.

### DETAILED DESCRIPTION OF EXEMPLARY EMBODIMENTS

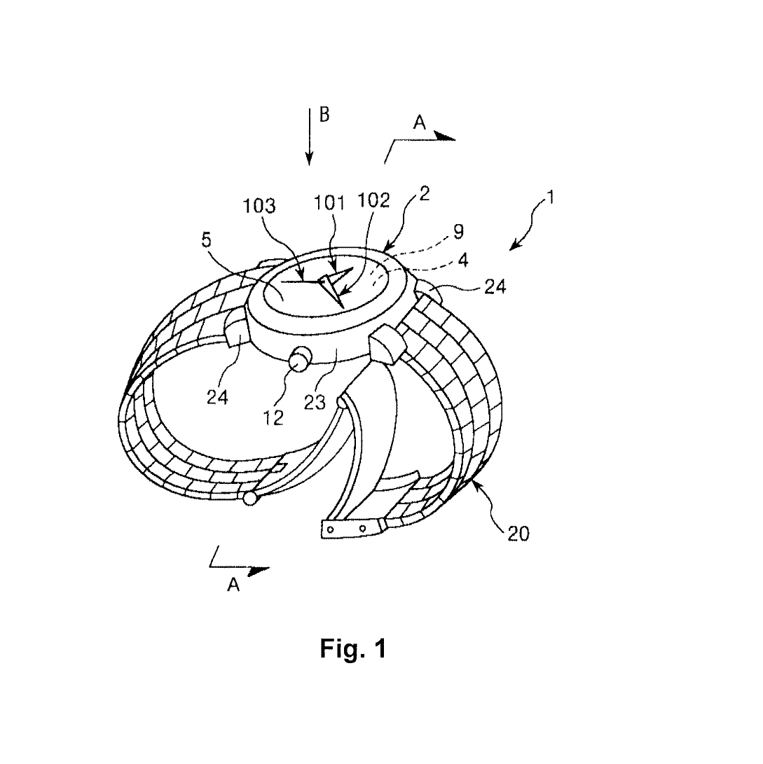

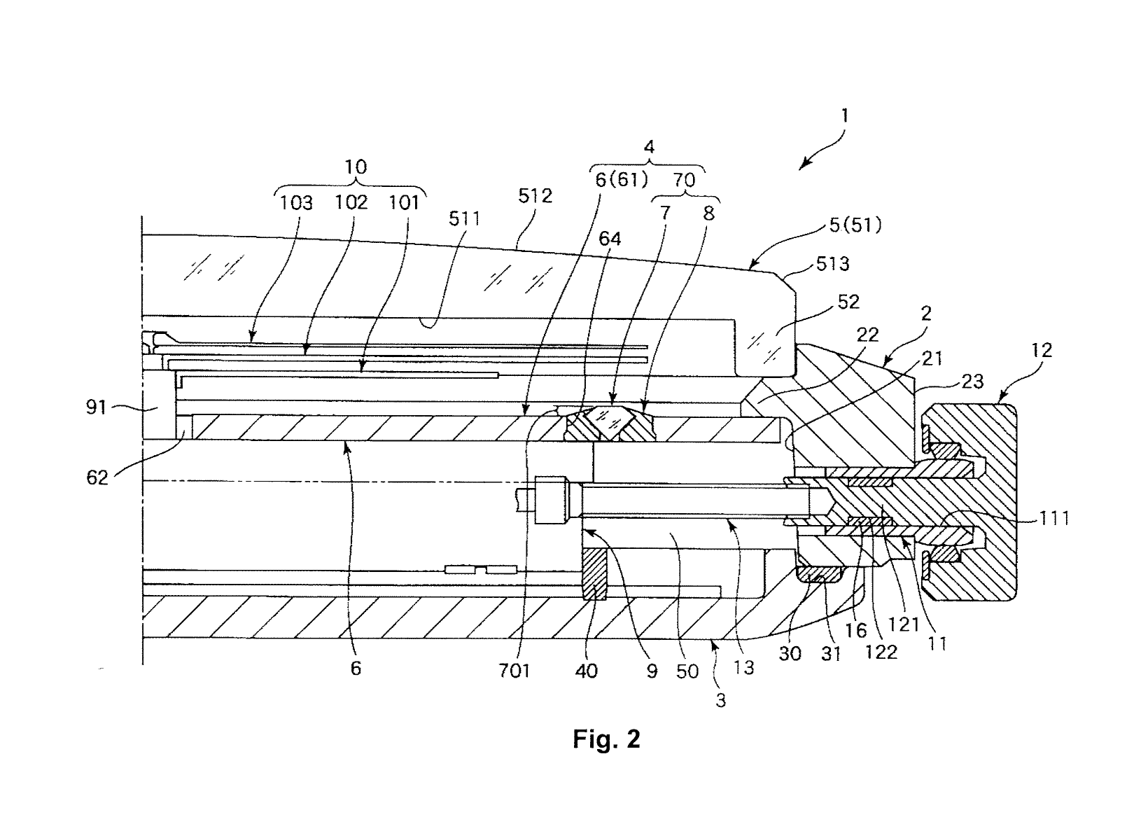

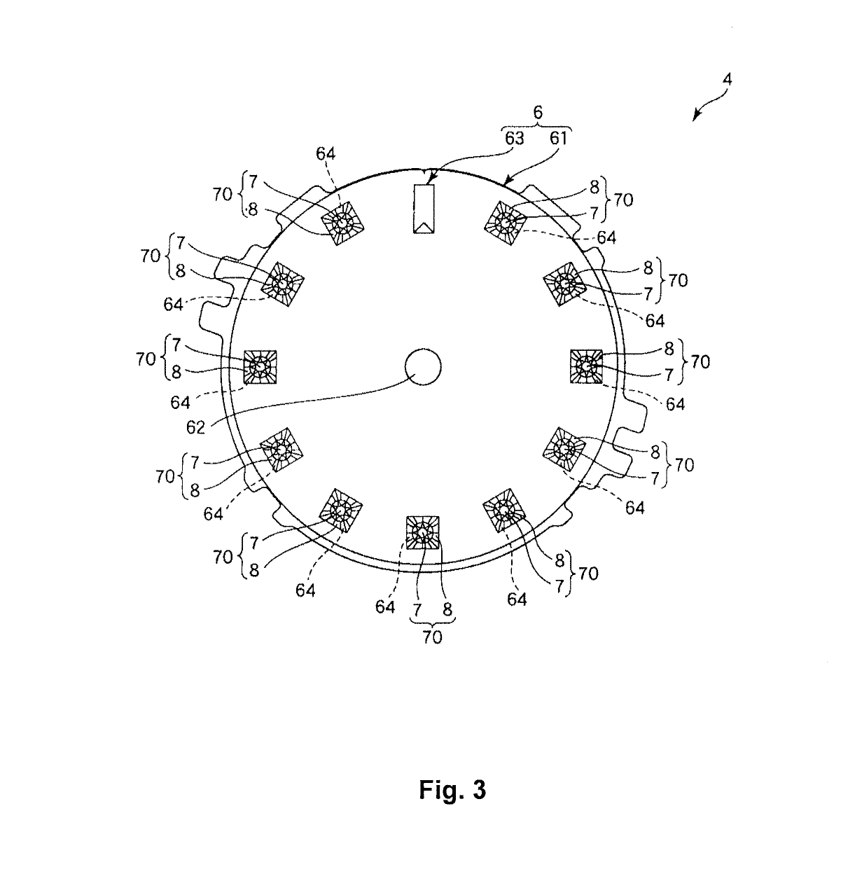

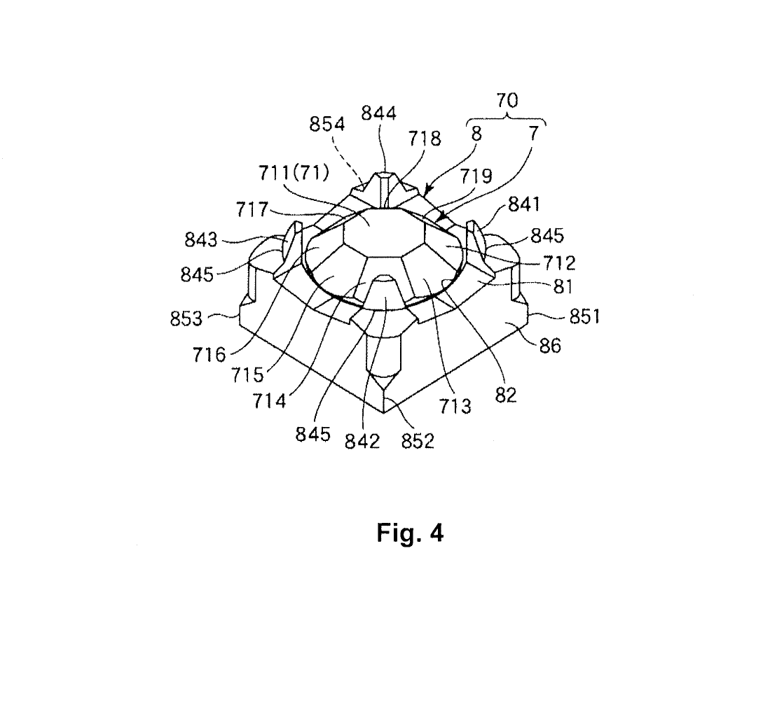

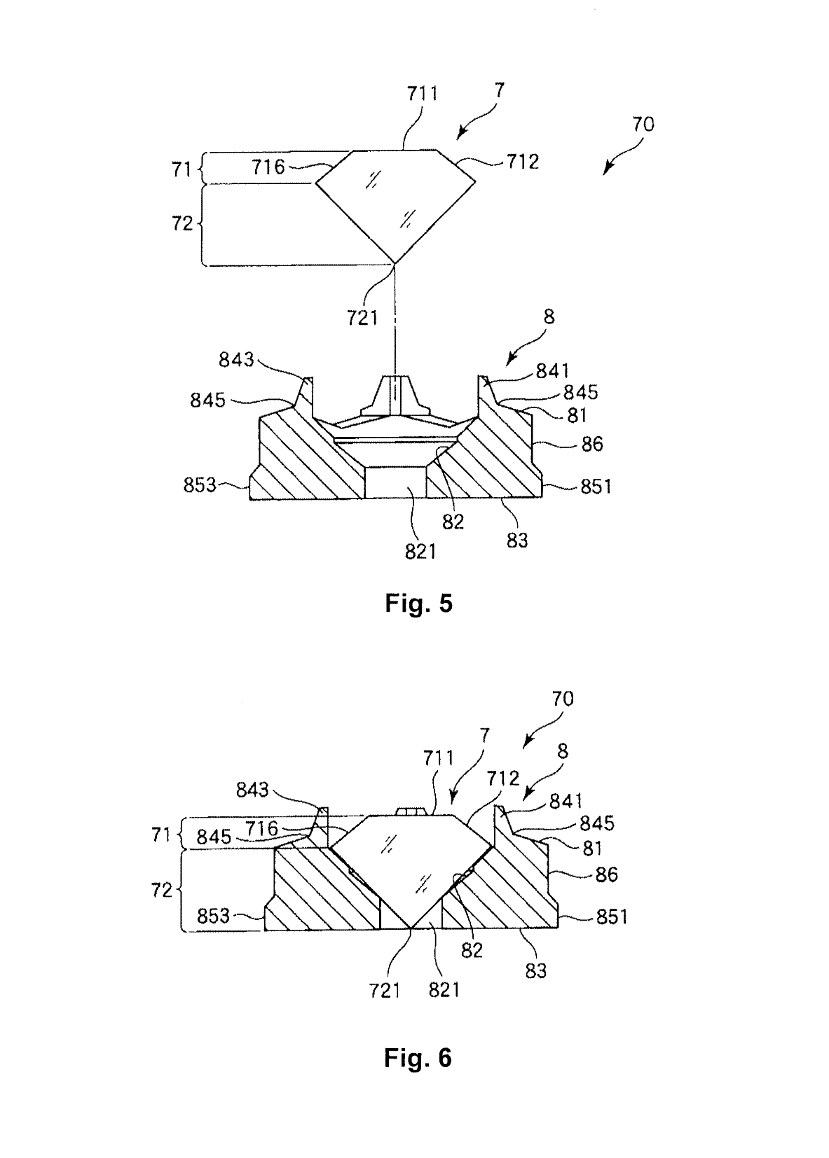

Following, we will give a detailed description of the dial assembly and timepiece of the invention based on preferred embodiments shown in the attached drawings. FIG. 1 is a perspective view showing an embodiment when the timepiece of the invention equipped with the dial assembly of the invention is used for a wrist watch. FIG. 2 is a cross section diagram of line A-A in FIG. 1. FIG. 3 is a diagram (plan view) of the dial assembly in FIG. 1 seen from the arrow B direction. FIG. 4 is a perspective view of a decorative structure with the timepiece shown in FIG. 1. FIG. 5 through FIG. 9 are cross section diagrams showing the assembly step order of the dial assembly of the invention. Following, according to the description circumstances, in FIG. 1, FIG. 2, and FIG. 4 through FIG. 9, the top side is referred to as “top,” “above” or “front,” and the bottom side is referred to as “bottom,” “below,” or “back.”

The wrist watch 1 shown in FIG. 1 and FIG. 2 (hereafter referred to simply as “watch”) is equipped with a body (case) 2, a back cover 3, a cover glass (watch crystal) 5, and a band 20. Also, in sequence from the side at which the cover glass 5 is provided, the dial assembly 4 and the movement 9 are held in the internal space 50 of the watch 1 (space enclosed by the body 2, the back cover 3, and the cover glass 5). Also, the indicators (hands) 10 (the hour hand 101, the minute hand 102, and the second hand 103) are supported to be able to rotate on the movement 9, and are held within the internal space 50 of the watch 1 together with the movement 9. Following, we will describe the constitution of each part.

As shown in FIG. 2, the body 2 is constituted by an annular member. A rib 22 is formed projecting toward the center side on the inner circumference part 21 of the body 2. The rib 22 is formed in a ring shape along the circumference direction of the inner circumference part 21. Also, a cover glass 5 is fixed to be air tight and liquid tight on this rib 22. As this fixing method, though not specifically restricted, an example that can be used is a method using adhesion (adhesion using an adhesive agent or solvent).

The cover glass 5 is constituted from a cover glass main unit 51 forming a round disk shape and a leg part 52 formed projecting as an integral unit on the surface 511 of the back side of the cover glass main unit 51. Note that the cover glass 5 is constituted from a transparent member. Note that a “transparent member” means an item having transparency for which the visible light transmission rate is about 50% or greater. Also, “transparent” includes transparency with color (colored) in addition to colorless transparency. As the constituent material of the cover glass 5, though not specifically restricted, for example inorganic glass or the like can be used. As this inorganic glass, examples include soda lime glass, borosilicate glass, Hardrex (inorganic tempered glass), Clearex (non-reflective treated), spinel glass, sapphire glass or the like. For inorganic glass, since the material strength (strength) is high, for example it is possible to reduce deformation and breaking due to pressure or impact, and to make it so that it does not scratch easily and also has good specularity. As a result, the strength of the cover glass 5 itself is high, and it is possible to improve visibility. Also, with inorganic glass, it is easily possible to perform adhesion using an adhesive agent, and thus, there is a wide range of selections of types of adhesive agent and adhesion method with which high adhesive strength can be obtained.

The cover glass main unit 51 is a curved convex surface for which its front side surface 512 is curved in convex form. As a result, for example, the overall watch 1 has excellent aesthetics and good design properties. Also, a chamfer part 513 for which chamfering is implemented is formed on the edge part of the front side of the cover glass main unit 51. As a result, even if skin comes into contact with the edge part of the front side of the cover glass main unit 51, it is possible to reliably prevent the skin being injured, giving the cover glass a high level of safety.

The leg part 52 forms a ring shape along the rib 22 of the body 2, and is a part that is fixed to that body 2. The inner diameter and the thickness (height) of the leg part 52 is not specifically restricted provided it is of a level for which it is possible to prevent interference with the indicator 10 of the cover glass 5. Also, at both sides via the center axis on the outer circumference part 23 of the body 2, lugs 24 are provided as connector parts by which the band 20 is connected (see FIG. 1). The band 20 is used when wearing the watch 1 on the arm.

A winding stem 11 is fit onto and fixed to the part between both lugs 24 of the outer circumference part 23 of the body 2. A shaft part 121 of a crown 12 is inserted to be able to rotate inside this winding stem 11. Furthermore, the shaft part 121 of the crown 12 is connected to the movement 9 via a shaft 13. Also, by doing a rotation operation of the crown 12, the rotation force is transmitted to the movement 9 via the shaft 13, and it is possible to adjust the position of the hour hand 101 and the minute hand 102.

A groove 122 is formed on the outer circumference midway on the shaft part 121 of the crown 12, and ring shaped rubber packing (crown packing) 16 is fit into this groove 122. The rubber packing 16 is adhered to the inner circumference surface 111 of the winding stem 11, and is compressed between the inner circumference surface 111 and the groove 122 inner surface. With this constitution, it is possible to have between the crown 12 and the winding stem 11 sealed liquid tight to have a water proofing function. Note that when a rotation operation is done with the crown 12, the rubber packing 16 rotates together with the shaft part 121, and it can slide in the circumference direction while being adhered to the inner circumference surface of the winding stem 11.

The back cover 3 is mounted by screwing or fitting, for example, on the back side of the body 2. The back cover 3 is constituted by a round disk shaped member. A recess 31 is formed along the circumference direction on the part of the top surface side (edge part) of the back cover 3. Packing 30 constituted by an elastic material is arranged on the recess 31. Then, when the back cover 3 is mounted on the body 2, the packing 30 is compressed, and it is possible to maintain an air tight and liquid tight state between the back cover 3 and the body 2.

As the constituent material for the body 2, the back cover 3, and the indicator 10, though not specifically restricted, examples include various metal materials such as stainless steel, titanium, and titanium alloys (including alloys), and various types of resin materials (plastic materials) and the like. Among these, metal materials are preferably used because they are excellent in terms of aesthetic aspect and strength. The body 2, the back cover 3, and the indicator 10 can be constituted using the same materials as each other, and can also be constituted using different materials.

A movement 9 is fixed to the back cover 3 via the fixing member 40. The movement 9 has a shaft 91 on which the hour hand 101, the minute hand 102, and the second hand 103 are rotationally supported. This movement 9 has a built in mechanism that drives (rotates) the hour hand 101, the minute hand 102, and the second hand 103 via the shaft 91 using power supplied from a button battery (not shown). This mechanism is not specifically restricted, but examples that can be used include a quartz oscillator as a time reference source, a semiconductor integrated circuit that generates a drive pulse for driving the watch based on the oscillating frequency of the quartz oscillator, a step motor for driving the indicator each second with the train wheel mechanism that receives this drive pulse, or an item equipped with the train wheel mechanism for transmitting the movement of the step motor to the indicator.

As shown in FIG. 2, the dial assembly 4 is placed on the movement 9. As shown in FIG. 3, the dial assembly 4 has a dial 5 and eleven decorative structures 70. As shown in FIG. 2 and FIG. 3, the dial 6 is constituted by a dial main unit 61 constituted with a member forming a plate shape (for example a round disk shape), and a display part (time scale) 63 arranged on the dial main unit 61.

The dial main unit 61 is sandwiched between the movement 9 and the rib 22 of the body 2. As a result, the dial 6 (dial assembly 4) is reliably fixed, and slipping during use of the watch is reliably prevented. At the center part of the dial main unit 61, an insertion hole 62 in which the shaft 91 of the movement 9 is inserted is formed.

On the front side surface 611 of the dial main unit 61 is fixed a strip of paper shaped display part 63 that displays the time by the indication of the hour hand 101, the minute hand 102, and the second hand 103. As the fixing method for this, though not specifically restricted, examples that can be used include a method using adhesion (adhesion using an adhesive agent or solvent), a method using fusion (thermal fusion, high frequency fusion, ultrasonic fusion and the like), a method using fitting, a method using crimping or the like. The display part 63 is arranged at a position corresponding to “12” of the numbers 1 to 12 expressing the time. The time can also be confirmed by the position indicated by the display part 63 respectively with the hour hand 101, the minute hand 102, and the second hand 103.

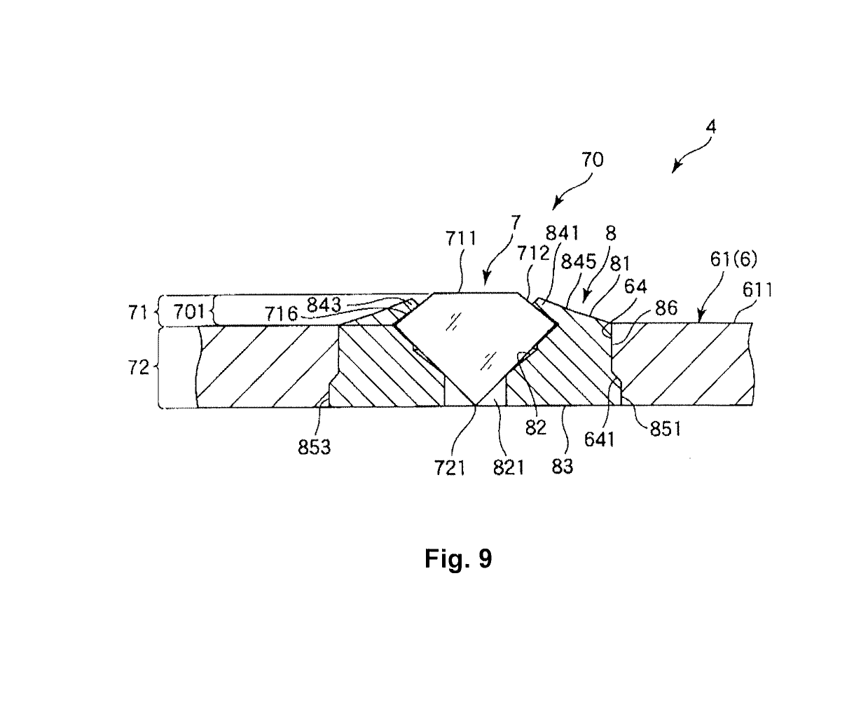

Also, fixing parts 64 for fixing the respective decorative structures 70 to the positions corresponding to “1” to “11” of the numbers 1 to 12 expressing the time of the dial main unit 61 (dial 6) are provided. Each fixing part 64 is respectively constituted by a through hole that pierces the dial main unit 61 in the thickness direction. Also, by the decorative structure 70 being inserted in the fixing part 64 constituted by this through hole, that decorative structure 70 is fitted and reliably fixed (see FIG. 8 and FIG. 9). It is possible to confirm the time by the respective position indicated respectively by the hour hand 101, the minute hand 102, and the second hand 103 at any of the decorative structures 70. As the constituent material for dial main unit 61 and the display part 63, though not specifically restricted, the same as for the body 2 constituent material, examples include various metal materials such as stainless steel, titanium, and titanium alloys (including alloys), and various types of resin materials (plastic materials) and the like. Among these, metal materials are preferably used because they are excellent in terms of aesthetic aspect and strength.

Each decorative structure 70 has the same constitution, so hereafter, we will give a representative description of one decorative structure 70. As shown in FIG. 2 to FIG. 9, the decorative structure 70 is constituted by a decorative member 7 and a support member 8. The decorative member 7 is a jewel which can be visually recognized via the cover glass 5 via the front side of the dial 6. Though not specifically restricted, as the jewel, examples that can be used include diamonds, sapphires, rubies, and the like. By constituting the decorative member 7 using this kind of jewel, the aesthetics of the watch 1 are improved, and that watch 1 becomes a luxury item (a so-called luxury wrist watch).

As shown in FIG. 5 to FIG. 9, this decorative member 7 can be divided into a multifaceted formed part 71 and a back side cone shaped part 72 (or pyramid shaped part). A plurality of flat planes are formed on the multifaceted formed part 71, and each plane faces a different direction from the others. With the constitution shown in FIG. 4, the multifaceted formed part 71 has a flat plane 711 facing upward and forming an octagon shape, and eight fan-shaped planes 712, 713, 714, 715, 716, 717, 718, and 719 formed tilting in mutually different directions in relation to a normal vector of the plane 711 on the periphery of the plane 711. With this kind of multifaceted formed part 71, light is reflected in multiple directions (diffused), further improving the attractiveness of the watch 1. The cone shaped part 72 is formed so that its center axis is parallel to the normal vector of the plane 711. This kind of decorative member 7 is supported on the dial main unit 61 of the dial 6 via the support member 8.

The support member 8 is constituted with a flat block unit made of metal. As the metal constituting the support member 8, though not specifically restricted, examples that can be used include various metal materials such as stainless steel, titanium, and titanium alloys (including alloys). A recess part 82 is formed at the center part of the front side surface 81 of the support member 8. The recess part 82 forms a shape corresponding to the external shape of the cone shaped part 72 of the decorative member 7, specifically, it forms a mortar shape. The cone shaped part 72 of the decorative member 7 is held in this recess part 82. Also, the part that is not held in the recess part 82 of the decorative member 7, specifically, the multifaceted formed part 71, is exposed, and can be visually recognized via the cover glass 5. A through hole 821 is formed on the bottom part of the recess part 82. The vertex 721 of the cone shaped part 72 is positioned inside this through hole 821.

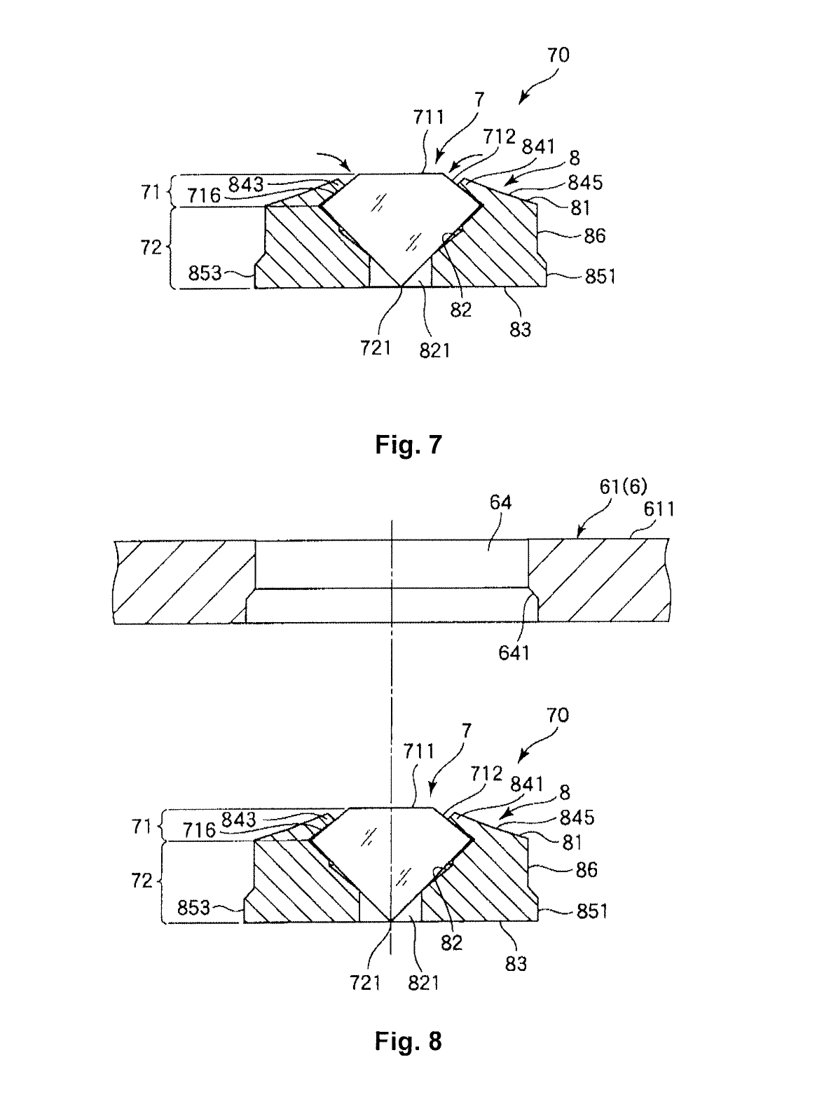

As shown in FIG. 4, four claw parts 841, 842, 843, and 844 are formed projecting on the front side surface 81 of the support member 8. The claw parts 841 to 844 are arranged at different positions from the recess part 82, specifically, at equal gaps along the periphery of the recess part 82. Also, the claw parts 841 to 844 respectively become gradually wider with the width facing downward. Then, the claw parts 841 to 844 can be bent by the base part 845 which is the boundary part with the front side surface 81 (see FIG. 6 and FIG. 7). The bent base part 845 is plastically deformed and maintains that bent state.

The claw parts 841 to 844 bent in this way by the base part 845 are respectively able to engage with the decorative member 7 held in the recess part 82 (see FIG. 7 to FIG. 9). With this embodiment, the claw part 841 is engaged with the plane 712 of the multifaceted formed part 71 of the decorative member 7, the claw part 842 is engaged with the plane 714 of the multifaceted formed part 71, the claw part 843 is engaged with the plane 716 of the multifaceted formed part 71, and the claw part 844 is engaged with the plane 718 of the multifaceted formed part 71. By this kind of engagement, the decorative member 7 is supported and fixed by the support member 8, and thus, it is possible to reliably prevent unintentionally falling off from the support member 8.

The claw parts 841 to 844 each have a portion that projects further upward than the plane 711 of the multifaceted formed part 71 of the decorative member 6 when in the state before being bent, and positioned below the plane 711 in the bent state (see FIG. 6 to FIG. 9). Also, engaging parts (projecting parts) 851, 852, 853, and 854 are formed projecting at the bottom part of the side surface 86 (corner) of the support member 8. The engaging part 851 is arranged at the outside of the claw part 841, the engaging part 852 is arranged at the outside of the claw part 842, the engaging part 853 is arranged at the outside of the claw part 843, and the engaging part 854 is arranged at the outside of the claw part 844.

Meanwhile, as shown in FIG. 8 and FIG. 9, a step part 641 for which the inner diameter changes in steps is formed respectively on the edge part of each fixing part 64 of the dial 6. When the decorative structure 70 (support member 8) is inserted in the fixing part 64 from the back side of the dial 6, the engaging parts 851 to 854 are engaged in the step part 641. As a result, the insertion depth of the decorative structure 70 in relation to the fixing part 64 is regulated, and thus, it is possible to reliably prevent the insertion of the decorative structure 70 from being excessive and the insertion of the decorative structure 70 from being insufficient. Also, as shown in FIG. 2 and FIG. 9, the decorative structure 70 inserted in the fixing part 64 of the dial 6 has a portion (the top part) projecting from the front side surface 611 of the dial 6. Following, that projecting part is called the “projecting part 701.”

As described above, with the dial assembly 4, in a state with the decorative member 7 held in the support member 8 and engaged, with these members assembled together, the decorative structure 70 is inserted in the fixing part 64 from the back side and fixed. By inserting from the back side in this way, compared to when inserted from the front side, by the amount of the overall thickness amount of the dial main unit 61, of the overall thickness (height) of the decorative structure 70, it is possible to suppress to the extent possible the projection volume (projection height) of the projecting part 701, specifically, the projection of the decorative member 7 from the front side surface 611 of the dial 6. As a result, as shown in FIG. 2, when the minute hand 102 and the second hand 103 are rotated, interference with the projecting part 701 is prevented, and thus, it is possible to pass through the front side (top side) further than the projecting part 701. Also, it is no longer necessary to shorten the minute hand 102 and the second hand 103, and thus, it is possible to prevent a decrease in the attractiveness of the watch 1.

Next, we will describe the method of assembling the dial assembly 4 while referring to FIG. 5 through FIG. 9.

[1] As shown in FIG. 5, the decorative members 7 and support members 8 respectively constituting each decorative structure 70 are prepared.

[2] Next, as shown in FIG. 6, the decorative member 7 is inserted from the front side of the support member 8 into the recess part 82 and held there. At this time, with the decorative member 7, the plane 712 of the multifaceted formed part 71 faces the claw part 841 of the support member 8, the plane 714 of the multifaceted formed part 71 faces the claw part 842 of the support member 8, the plane 716 of the multifaceted formed part 71 faces the claw part 843 of the support member 8, and the plane 718 of the multifaceted formed part 71 faces the claw part 844 of the support member 8.

[3] Next, as shown in FIG. 7, the claw parts 841 to 844 are respectively bent by the base part 845. As a result, the claw part 841 engages with the plane 712 of the decorative member 7, the claw part 842 engages with the plane 714 of the decorative member 7, the claw part 843 engages with the plane 716 of the decorative member 7, and the claw part 844 engages with the plane 718 of the decorative member 7. Thus, it is possible to obtain a decorative structure 70 for which the decorative member 7 is supported and fixed by the support member 8. Eleven such decorative structures 70 are assembled.

[4] Next, as shown in FIG. 8, each of the assembled decorative structures 70 is inserted from the back side of the fixing part 64 of the dial 6. As shown in FIG. 9, the degree of insertion is until the engaging parts 851 to 854 of the support member 8 contact the step part 641 of the fixing part 64. As a result, a dial assembly 4 is obtained for which the projection volumes of the projecting parts 701 of each decorative structure 70 are all the same (uniform).

Above, we described the dial assembly and the watch of the invention using the embodiments in the drawings, but the invention is not limited to this, and each part constituting the dial assembly and the watch can be substituted with any constitution for which the same function can be exhibited. Also, any structural element can also be added. Also, the number of decorative structures arranged with the dial assembly was eleven with this embodiment, but the invention is not limited to this, and for example can be one, two, three, four, five, six, seven, eight, nine, ten, or twelve. Also, with this embodiment, among the hour hand, minute hand and second hand, the watch was constituted with the minute hand and the second hand passing through the front side of the projecting part of the decorative structure, but the invention is not limited to this, and it is also possible to constitute this with all the indicators of the hour hand, minute hand, and second hand passing through the front side of the projecting part of the decorative structure.

What is claimed is:

1. A dial assembly which is held inside a timepiece case together with a movement that supports an hour hand and minute hand to be able to rotate, the dial assembly comprising:
a plate shaped dial, and
at least one decorative structure having a decorative member which can be visually recognized from the front side of the dial, and a support member by which the decorative member is supported on the dial, wherein
the dial has a fixing member for fixing the decorative member, which is constituted with through holes that pierce the dial in the thickness direction, and
in a state in which the decorative member and the support member are assembled, the decorative structure is inserted in the fixing part from the back side of the dial to be fixed.

2. The dial assembly according to claim 1, wherein with the decorative structure, one portion projects from the front side surface of the dial, and of the hour hand and the minute hand, at least the minute hand passes through the front side further than that one portion.

3. The dial assembly according to claim 1, wherein the support member is constituted with a block unit, and a projecting part is formed projecting to the side surface, engaging with the edge part of the fixing part, and regulates the insertion depth in relation to the fixing part.

4. The dial assembly according to claim 1, wherein the support member is constituted with a block unit, and on the front side surface is formed a recess part in which the decorative member is held.

5. The dial assembly according to claim 4, wherein a plurality of claw parts are formed projecting on the front side surface of the support member at positions different from the recess parts, and
each of the claw parts is respectively bent and engaged with the decorative member in a state with the decorative member held in the recess part.

6. The dial assembly according to claim 1, wherein the decorative member is a jewel.

7. The dial assembly according to claim 1, wherein the decorative structure is an item corresponding to at least one number among 1 to 12 expressing time on the dial.

8. A timepiece comprising:
the dial assembly according to claim 1,
a movement that supports an hour hand and minute hand to be able to rotate, and
a case in which the dial assembly and the movement are held.
